(19) United States
(12) Patent Application Publication
(10) Pub. No.: US 2024/0020737 A1
(43) Pub. Date: Jan. 18, 2024

(54) COMMERCIAL LAUNDRY APPLIANCES ENERGY-BASED PRICING

(71) Applicant: Haier US Appliance Solutions, Inc., Wilmington, DE (US)

(72) Inventors: Ryan James Scheckelhoff, Louisville, KY (US); Joshua Reeves, Louisville, KY (US)

(21) Appl. No.: 17/866,918

(22) Filed: Jul. 18, 2022

(51) Int. Cl. G06Q 30/02; D06F 34/05; D06F 95/00; G06Q 20/26

(52) U.S. Cl. CPC G06Q 30/0283; D06F 34/05; D06F 95/00; G06Q 20/26

(57) ABSTRACT

A method of operating a commercial laundry appliance includes receiving energy cost information for one or more operation cycles of the commercial laundry appliance and updating a price for the commercial laundry appliance based on the energy cost information. The method also includes activating the commercial laundry appliance after receiving payment of the updated price.

### FIELD OF THE INVENTION

The present subject matter relates generally to laundry appliances with features for dynamic pricing based on related energy costs.

### BACKGROUND OF THE INVENTION

Laundry appliances generally include washing machine appliances and dryer appliances. Such laundry appliances are typically paired, such that after washing a load of articles in the washing machine appliance of the pair, the load of articles may be easily transferred to the dryer appliance that is paired with the washing machine appliance.

Some laundry appliances, such as commercial laundry appliances, may be rented by a user, e.g., the user pays an agreed-upon price for each cycle the user selects and initiates on the laundry appliance. Such commercial laundry appliance may be found in a laundromat, dormitory, or apartment building, etc. Typically, the price for each cycle in a commercial laundry appliance is static. However, the owner's cost for operating the commercial laundry appliance may vary for several reasons, such as due to varying energy costs which can change from day to day or may even vary at different times of day within the same day. For example, energy costs may increase at peak demand times. Further, the environmental impact of operating the commercial laundry appliance may be greater at peak energy demand times.

Thus, systems and methods for energy cost based dynamic pricing in commercial laundry appliances would be beneficial.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of operating a plurality of commercial laundry appliances is provided. Each of the commercial laundry appliances in the plurality of commercial laundry appliances includes a user interface and a controller in operative communication with the user interface. The method includes receiving energy cost information for one or more operation cycles of the plurality commercial laundry appliances. The method also includes determining which commercial laundry appliances in the plurality of commercial laundry appliances are currently available. The method further includes updating a price for each currently available commercial laundry appliance in the plurality of commercial laundry appliances based on the energy cost information. The method also includes receiving payment of the updated price at one of the currently available commercial laundry appliances and activating the commercial laundry appliance at which the payment was received after receiving payment of the updated price.

In accordance with another embodiment of the present disclosure, a method of operating a commercial laundry appliance is provided. The commercial laundry appliance includes a user interface and a controller in operative communication with the user interface. The method includes receiving energy cost information for one or more operation cycles of the commercial laundry appliance. The method also includes updating a price for the commercial laundry appliance based on the energy cost information. The method further includes activating the commercial laundry appliance after receiving payment of the updated price.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a schematic diagram of a laundry appliance in communication with a remote user interface device and a remote database according to one or more embodiments of the present disclosure.

FIG. 5 provides a schematic diagram of a plurality of laundry appliances in communication with a remote database.

FIG. 6 provides a flowchart illustrating an example method of operating a plurality of commercial laundry appliances according to one or more embodiments of the present disclosure.

FIG. 7 provides a flowchart illustrating an example method of operating a commercial laundry appliance according to one or more additional embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

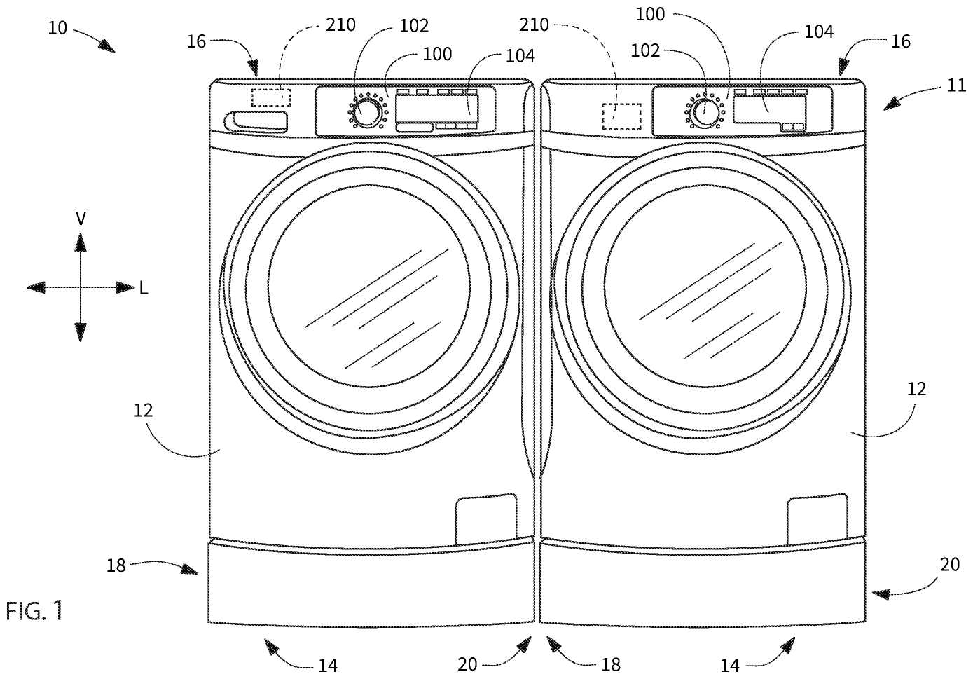

As may be seen in FIGS. 1 through 3, in accordance with one or more embodiments of the present subject matter, a laundry appliance or a plurality of laundry appliances, such as a group of at least two laundry appliances, e.g., a pair of laundry appliances, is provided. As may be seen generally throughout FIGS. 1 through 3, a user interface panel 100 and a user input device 102 may be positioned on an exterior of the laundry appliance or each laundry appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each laundry appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, laundry appliances may include a washing machine appliance 10 and a dryer appliance 11. In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each laundry appliance 10 and 11.

As generally seen throughout FIGS. 1 through 3, in at least some embodiments, each laundry appliance 10 and 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

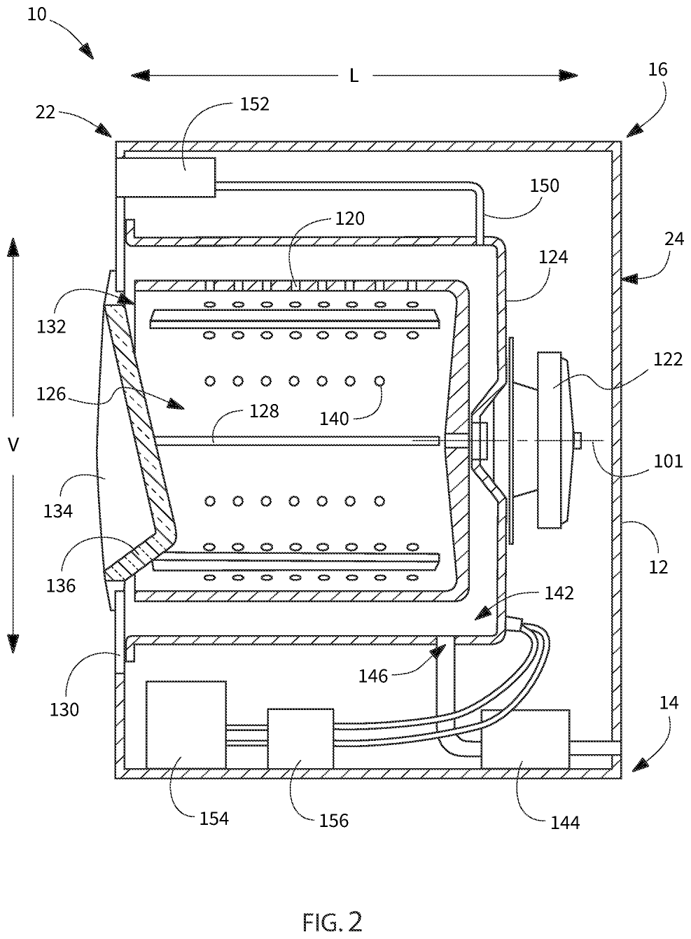

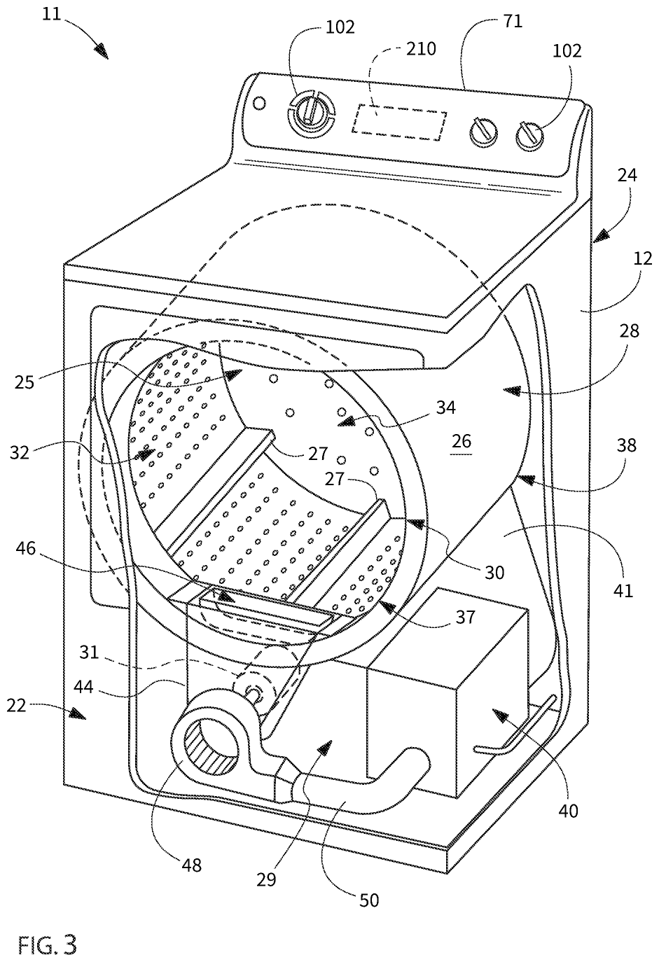

Additional exemplary details of the laundry appliances are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, e.g., during a wash cycle of the washing machine appliance 10, a laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a laundry appliance, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other similar items. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, application-specific integrated circuit (ASICS), or semiconductor devices and is not restricted necessarily to a single element. The controller 210 may be programmed to operate dryer appliance 11 by executing instructions stored in memory (e.g., non-transitory media). The controller 56 may include, or be associated with, one or more memory elements such as random access memory (RAM), read-only memory (ROM), or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

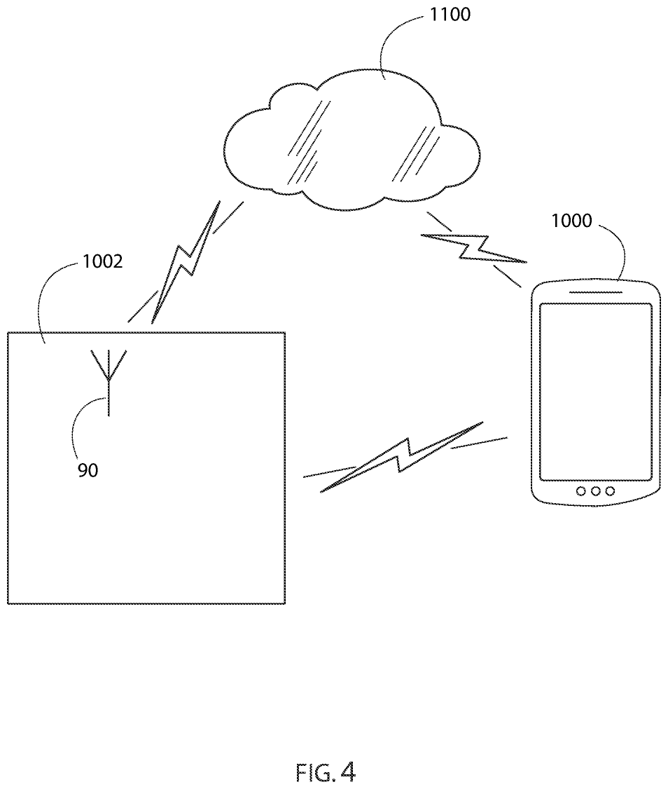

Turning now to FIG. 4, a general schematic of a laundry appliance 1002, which may be, e.g., the washing machine appliance 10 or the dryer appliance 11 described above (or both) and communication features thereof. FIG. 4 schematically illustrates a laundry appliance 1002, which may be, for example, one of the laundry appliances 10 or 11 of FIGS. 1 through 3, among other possible example laundry appliances, which communicates wirelessly with a remote user interface device 1000. For example, as illustrated in FIG. 4, the laundry appliance 1002 may include an antenna 90 by which the laundry appliance 1002 communicates with, e.g., sends and receives signals to and from, the remote user interface device 1000. The laundry appliance 1002 may communicate with the remote user interface device 1000 over a direct wireless communication link or over an indirect wireless communication link, such as via one or more remote computing devices 1100, such as a remote server, a network, or cloud. The remote user interface device 1000 may be a laptop computer, smartphone, tablet, personal computer, wearable device, smart home system, and/or various other suitable devices.

The laundry appliance 1002 may be in communication with the remote user interface device 1000 device through various possible communication connections and interfaces. The laundry appliance 1002 and the remote user interface device 1000 may be matched in wireless communication, e.g., connected to the same wireless network. The laundry appliance 1002 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the appliance 10 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the laundry appliance 1002, e.g., the remote user interface device 1000 is a separate, stand-alone device from the laundry appliance 1002 which communicates with the laundry appliance 1002 wirelessly. Any suitable device separate from the laundry appliance 1002 that is configured to provide and/or receive communications, information, data, or commands from a user may serve as the remote user interface device 1000, such as a smartphone (e.g., as illustrated in FIG. 4), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

As mentioned above, the laundry appliance 1002 may also be configured to communicate wirelessly with one or more remote computing devices 1100. The remote computing device(s) 1100 may be or include, e.g., a remote database such as a cloud-based data storage system, a remote server, and/or other similar remote computing devices with which the laundry appliance 1002 may communicate over a network or in a distributed computing environment. For example, the laundry appliance 1002 may communicate with the remote computing device(s) 1100 over the Internet, which the laundry appliance 1002 may access via WI-FI®, such as from a WI-FI® access point in a user's home.

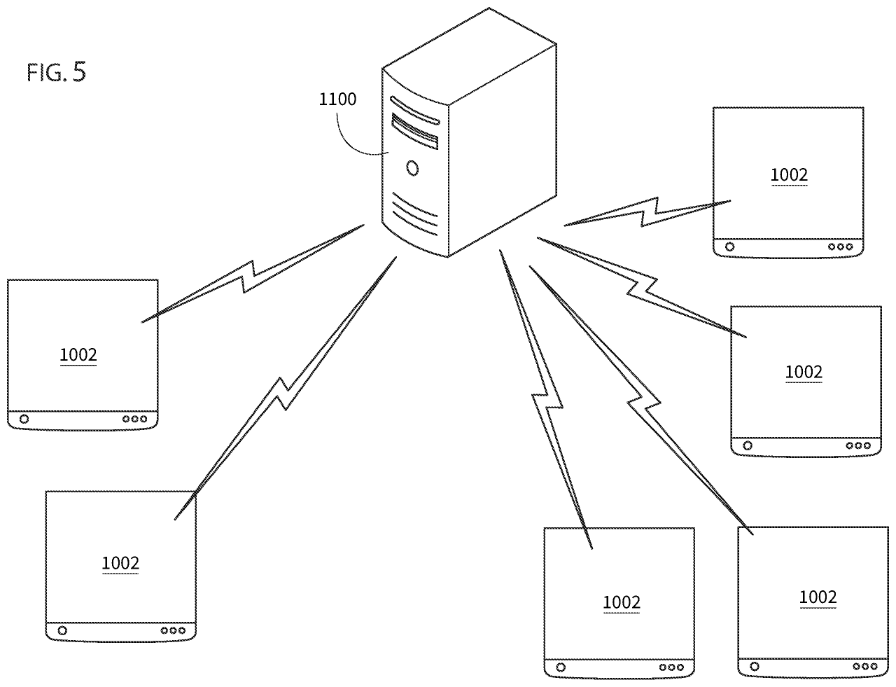

FIG. 5 schematically illustrates a plurality of laundry appliances 1002, such as a group or set of laundry appliances which may be commonly owned, such as in the same laundromat, apartment building, etc. As illustrated in FIG. 5, each laundry appliance 1002 of the plurality of laundry appliances 1002 is in communication with one or more remote computing devices 1000, e.g., a remote database, as described above. Methods and systems according to the present disclosure may also include operating a plurality of laundry appliances 1002. For example, methods according to the present disclosure may include simultaneously and automatically updating pricing on the plurality of laundry appliances 1002, e.g., on all laundry appliances in the same laundromat at once. The laundry appliances 1002 in the plurality of laundry appliances 1002 may all be the same type of laundry appliance, e.g., all washing machine appliances or all dryer appliances, or may include both washing machine appliances and dryer appliances.

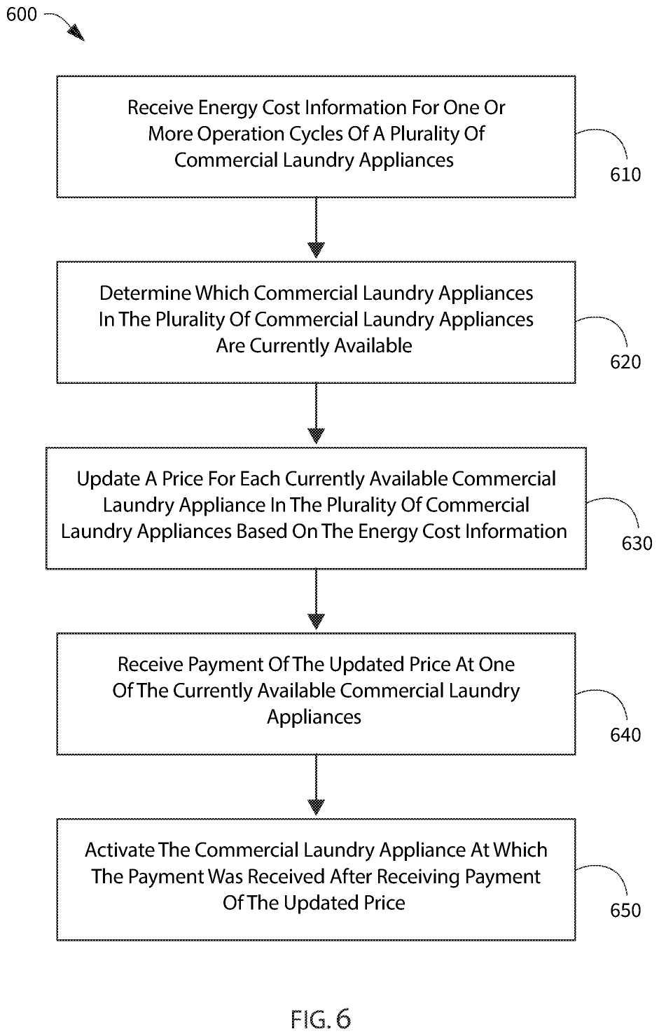

As illustrated in FIG. 6, embodiments of the present disclosure also include methods of operating a plurality of commercial laundry appliances, e.g., such as a plurality of laundry appliances 1002, which may include one or both the laundry appliances 10 and 11, described above, among other possible exemplary laundry appliances. Exemplary methods according to the present subject matter include the method 600 illustrated in FIG. 6.

As illustrated in FIG. 6, the method 600 may include a step 610 of receiving energy cost information for one or more operation cycles of the plurality commercial laundry appliances. For example, the energy cost information may include electric power cost information, fossil fuel (e.g., natural gas) cost information, or other energy cost information, including combinations of cost information for multiple energy sources. The cost information may include cost information for running one or more operation cycles, such as one or more drying cycles in embodiments where the plurality of commercial laundry appliances is or includes dryer appliances.

Still referring to FIG. 6, method 600 may also include a step 620 of determining which commercial laundry appliances in the plurality of commercial laundry appliances are currently available, e.g., such that laundry appliances which are currently in use or currently reserved will not have their prices adjusted, e.g., the price of using the one or more commercial laundry appliances which are in use or already reserved will not change mid-cycle or otherwise after payment has been accepted, and/or reservations made at a certain price will be honored at the reserved price (regardless of whether the updated price is an increased or decreased price). Thus, method 600 may further include a step 630 of updating a price for each currently available commercial laundry appliance in the plurality of commercial laundry appliances based on the energy cost information, such as only the currently available (not in use or reserved) commercial laundry appliances will reflect the updated pricing. The updated price may be based on the energy cost information in that the update is performed in response to the energy cost information. In some embodiments, the updated price may be based on the energy cost information in that the amount of the updated price is proportional to the energy cost information, such as an increased price when the energy cost goes up, or a decreased price when the energy cost goes down, such as increasing or decreasing the price by the same or generally the same ratio or proportion, e.g., percentage, as the energy cost.

Also as may be seen in FIG. 6, in some embodiments, method 600 may also include receiving payment of the updated price at one of the currently available commercial laundry appliances, e.g., as indicated at 640 in FIG. 6. Such payment may be received directly at the one of the currently available commercial laundry appliances, or indirectly at the one of the currently available commercial laundry appliances such as remotely, e.g., from any remote device which communicates with the one currently available commercial laundry appliance, such as to unlock the one currently available commercial laundry appliance for which payment was received. Method 600 may further include activating the commercial laundry appliance at which the payment was received after receiving payment of the updated price, such as initiating a selected operation cycle of the commercial laundry appliance.

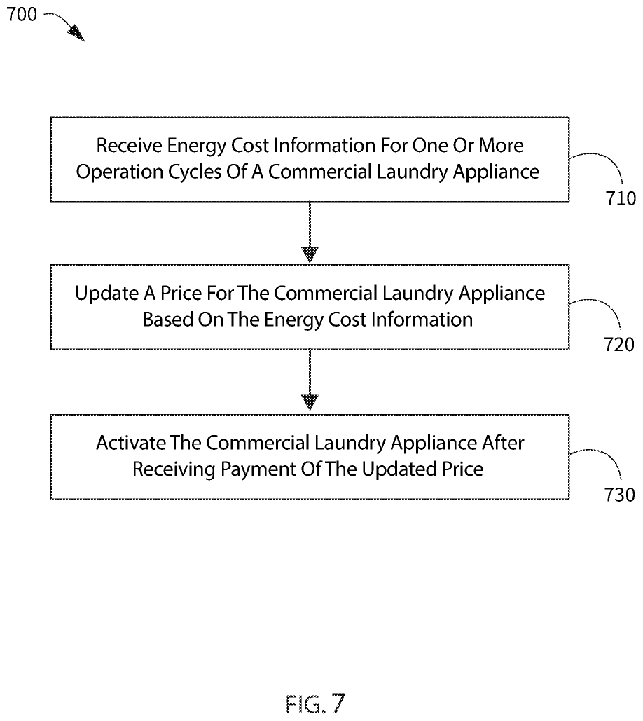

Turning now to FIG. 7, another exemplary method 700 of operating a commercial laundry appliance, e.g., which may be one of the laundry appliances 10 and 11 described above, among other possible exemplary laundry appliances, is illustrated therein.

As illustrated in FIG. 7, method 700 may include receiving energy cost information for one or more operation cycles of the commercial laundry appliance, e.g., as indicated at 710 in FIG. 7. Method 700 may also include updating a price for the commercial laundry appliance based on the energy cost information, e.g., at indicated at 720 in FIG. 7, and activating the commercial laundry appliance after receiving payment of the updated price, e.g., as indicated at 720 in FIG. 7.

Activating the commercial laundry appliance, e.g., in step 650 of method 600 and/or in step 730 of method 700, includes causing at least one mechanical component of the commercial laundry appliance to be operated. For example, the mechanical component may be a motor, such as the motor 122 of the washing machine appliance or the motor 31 of the dryer appliance, a fan, a heating element, a pump, a compressor, or a valve, among other possible example mechanical components of a commercial laundry appliance. Also, operating the mechanical component includes changing a physical status of the component, e.g., a speed, position, etc. of the component, such as accelerating the motor, fan, etc., e.g., from a zero starting speed, opening a valve, and/or other changes in the physical state of one or more mechanical components of the commercial laundry appliance.

In particular embodiments, some of the one or more operation cycles for which the energy cost information is received at 610 or 710 may be energy-intensive operation cycles, e.g., drying cycles. For example, an energy-intensive drying cycle or cycles may be or include a high heat cycle (e.g., as compared to a medium heat cycle, a low heat cycle, and/or an extra-low heat cycle), a rapid dry cycle, or a cycle for large loads, heavily saturated loads and/or highly water-absorptive loads (e.g., towels). Further, it is understood that an energy-intensive cycle may be defined in relation to other operation cycles, such as an energy-intensive cycle may be an operation cycle that uses more energy that at least one other operation cycle of the laundry appliances, such as uses more energy than one-third or one-half of the other operation cycles of the laundry appliance, such as uses more energy than an average energy use of all operation cycles of the laundry appliance.

The energy cost information may include a direct or specific cost, e.g., in dollars or cents (or any other suitable currency), per unit of energy, such as per kilowatt-hour (kW-h), e.g., for electric laundry appliances or per British thermal unit (BTU), e.g., for natural gas laundry appliances, such as a dryer appliance with a gas burner in the heating system. The energy cost information may include a general cost, such as a current cost band, e.g. high, medium, or low, or red, yellow, or green, etc., among other possible systems for classifying ranges of costs and/or generally identifying the current energy cost level compared to other recent historical energy costs. Such specific or general costs may be received from various sources, such as directly from an energy provider, e.g., over the internet from an electric provider or gas provider, etc.

In some embodiments, the energy cost information may also or instead be received from an alternative information source. In such embodiments, the method 600 or 700 may further include inferring an energy cost for the one or more operation cycles of the commercial laundry appliance. For example, the alternative information source may be a weather forecast or a time of day. In such embodiments, the energy cost may be inferred based on whether the weather will be unusually hot or cold, such as when an increased demand for energy to cool or heat homes, offices, and other building may be anticipated based on the weather. Also in such embodiments, the energy cost may be inferred based on changes in demand throughout the day based on the time of day as well as or instead of the weather. For example, energy use on weekdays (and consequently, energy costs in many cases) is higher in the mornings, e.g., between about 6:00 AM and about 8:00 AM, and in the evenings, e.g., between about 5:00 PM and about 11:00 PM, whereby the energy costs for the commercial laundry appliance or each currently available commercial laundry appliance may be inferred to be higher during such time ranges.

Referring now generally to FIGS. 6 and 7, in some embodiments, the energy cost information may be received by the controller of the commercial laundry appliance, such as the controller of each commercial laundry appliance. In such embodiments, the price may be updated by the controller of the commercial laundry appliance or the controller of each of the currently available commercial laundry appliances. In additional embodiments, the energy cost information may also or instead be received by a remote user interface device. For example, in some embodiments where the energy cost information is received by the remote user interface device, updating the price for each currently available commercial laundry appliance may be performed manually, such as by the owner of the commercial laundry appliance or each currently available commercial laundry appliance, e.g., after receiving and in response to or based on the energy cost information.

In some embodiments, updating the price for the commercial laundry appliance or each currently available commercial laundry appliance may be performed using the user interface of the commercial laundry appliance or of each currently available commercial laundry appliance. For example, such updates may be performed by entering an owner mode, e.g., authenticating the owner's identity and then unlocking additional controls for the commercial laundry appliance, such as unlocking a price adjustment or update feature. In such embodiments, the updated price may be updated by directly inputting the new price using the user interface of the commercial laundry appliance or the user interface of each of the currently available commercial laundry appliances. In additional embodiments, the price update may be performed using the user interface of the commercial laundry appliance or of each currently available commercial laundry appliance by confirming or accepting an updated price with the user interface of the commercial laundry appliance, where the updated price may be received from the remote user interface device. Thus, some embodiments may include using both the remote user interface device and the user interface of the commercial laundry appliance (or each of the currently available commercial laundry appliances) to complete the operation of updating the price for the commercial laundry appliance, or each currently available commercial laundry appliance in the plurality of commercial laundry appliances, based on the energy cost information.

In some embodiments, updating the price for the commercial laundry appliance or each currently available commercial laundry appliance may be performed using a remote user interface device. For example, the remote user interface device may be in wireless communication with the controller of the commercial laundry appliance or each currently available commercial laundry appliance, e.g., as described above in reference to FIGS. 4 and 5. In some embodiments, the entire price updating operation may be completed using only the remote user interface device. In additional embodiments, updating the price for the commercial laundry appliance or each currently available commercial laundry appliance may be performed using a remote user interface device by sending the updated price to the commercial laundry appliance or each currently available commercial laundry appliance from the remote user interface device and then accepting or acknowledging the updated price locally, e.g., on the user interface of the commercial laundry appliance or of each currently available commercial laundry appliance, as described above.

In some embodiments, updating the price for the commercial laundry appliance or each currently available commercial laundry appliance may include updating the price for all operation cycles of each currently available commercial laundry appliance. For example, the updated price may be an across-the-board update, e.g., increase or decrease, applied equally to all operation cycles, e.g., the same amount or percentage increase or decrease to the price of each operation cycle of the commercial laundry appliance. In additional embodiments, only the price for selected operation cycles, such as one or more energy-intensive operation cycles as discussed above, may be updated. In exemplary embodiments, updating the price for the commercial laundry appliance or each currently available commercial laundry appliance may include updating the price for an energy-intensive operation cycle of each currently available commercial laundry appliance, such as one or more energy-intensive operation cycles, such as only the energy-intensive operation cycle or cycles.

It should be understood that at least some of the foregoing method steps, e.g., of method 600 and/or method 700, may be performed by the remote user interface device, such as in an app running on, e.g., a smartphone or tablet, or in a software application running on a desktop computer or laptop computer. For example, the remote user interface device may be used to receive energy cost information and/or to set or update a price for one or more laundry appliances.

Still referring generally to FIGS. 6 and 7, the methods 600 and/or 700 may be interrelated and/or may have one or more steps from one of the methods 600 and 700 combined with the other method 600 or 700. Thus, those of ordinary skill in the art will recognize that the various steps of the exemplary methods described herein may be combined in various ways to arrive at additional embodiments within the scope of the present disclosure.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a plurality of commercial laundry appliances, each of the commercial laundry appliances in the plurality of commercial laundry appliances comprising a user interface and a controller in operative communication with the user interface, the method comprising:
receiving energy cost information for one or more operation cycles of the plurality commercial laundry appliances;
determining which commercial laundry appliances in the plurality of commercial laundry appliances are currently available;
updating a price for each currently available commercial laundry appliance in the plurality of commercial laundry appliances based on the energy cost information;
receiving payment of the updated price at one of the currently available commercial laundry appliances; and
activating the commercial laundry appliance at which the payment was received after receiving payment of the updated price.

2. The method of claim 1, wherein the energy cost information is received by the controller of each commercial laundry appliance and the price is updated by the controller of each of the currently available commercial laundry appliances.

3. The method of claim 1, wherein the energy cost information is received by a remote user interface device.

4. The method of claim 3, wherein updating the price for each currently available commercial laundry appliance is performed manually.

5. The method of claim 1, wherein updating the price for each currently available commercial laundry appliance is performed using the user interface of each currently available commercial laundry appliance.

6. The method of claim 1, wherein updating the price for each currently available commercial laundry appliance is performed using a remote user interface device, wherein the remote user interface device is in wireless communication with the controller of each currently available commercial laundry appliance.

7. The method of claim 1, wherein updating the price for each currently available commercial laundry appliance comprises updating the price for all operation cycles of each currently available commercial laundry appliance.

8. The method of claim 1, wherein updating the price for each currently available commercial laundry appliance comprises updating the price for an energy-intensive operation cycle of each currently available commercial laundry appliance.

9. The method of claim 1, wherein the energy cost information is received directly from an energy provider.

10. The method of claim 1, wherein the energy cost information is received from an alternative information source, further comprising inferring an energy cost for the one or more operation cycles of the commercial laundry appliance.

11. A method of operating a commercial laundry appliance, the commercial laundry appliance comprising a user interface and a controller in operative communication with the user interface, the method comprising:
receiving energy cost information for one or more operation cycles of the commercial laundry appliance;
updating a price for the commercial laundry appliance based on the energy cost information; and
activating the commercial laundry appliance after receiving payment of the updated price.

12. The method of claim 11, wherein the energy cost information is received by the controller of the commercial laundry appliance and the price is updated by the controller.

13. The method of claim 11, wherein the energy cost information is received by a remote user interface device.

14. The method of claim 13, wherein updating the price for the commercial laundry appliance is performed manually.

15. The method of claim 11, wherein updating the price for the commercial laundry appliance is performed using the user interface of the commercial laundry appliance.

16. The method of claim 11, wherein updating the price for the commercial laundry appliance is performed using a remote user interface device, wherein the remote user interface device is in wireless communication with the controller of the commercial laundry appliance.

17. The method of claim 11, wherein updating the price for the commercial laundry appliance comprises updating the price for all operation cycles of the commercial laundry appliance.

18. The method of claim 11, wherein updating the price for the commercial laundry appliance comprises updating the price for an energy-intensive operation cycle of the commercial laundry appliance.

19. The method of claim 11, wherein the energy cost information is received directly from an energy provider.

20. The method of claim 11, wherein the energy cost information is received from an alternative information source, further comprising inferring an energy cost for the one or more operation cycles of the commercial laundry appliance.
